(19) United States
(12) Patent Application Publication
(10) Pub. No.: US 2023/0177420 A1
(43) Pub. Date: Jun. 8, 2023

(54) METHOD AND SYSTEM FOR MANAGING STATEMENT EVENTS

(71) Applicant: JPMorgan Chase Bank, N.A., New York, NY (US)

(72) Inventors: Chandra GORANTLA, Sugar Land, TX (US); Karthigeyan KUPPAN, Houston, TX (US)

(73) Assignee: JPMorgan Chase Bank, N.A., New York, NY (US)

(21) Appl. No.: 17/643,002

(22) Filed: Dec. 7, 2021

(51) Int. Cl. G06Q 10/06

(52) U.S. Cl. CPC G06Q 10/063114; G06Q 10/06316

(57) ABSTRACT

A method for facilitating management of a plurality of statement events is disclosed. The method includes receiving an event, the event relating to an agreement status of a statement; retrieving a profile that corresponds to the statement, the profile including a statement dependency and a rule; mapping the statement based on the statement dependency and the rule; aggregating data that corresponds to the statement from a source; determining a completion status that corresponds to the statement; and publishing a ready event that corresponds to the statement based on a result of the mapping, the aggregated data, and the completion status.

### BACKGROUND

### 1. Field of the Disclosure

This technology generally relates to methods and systems for managing statement events, and more particularly to methods and systems for managing statement events and corresponding agreements based on predetermined rules to facilitate automated statement generation.

### 2. Background Information

Many business entities generate various statements to provide information to clients. Often, generation of the statements require satisfaction of numerous agreements such as, for example, service level agreements between the business entities and the clients. Historically, implementations of conventional statement event managers have resulted in varying degrees of success with respect to effective and efficient statement generation.

One drawback of using the conventional statement event managers is that in many instances, statements have several agreements that must be satisfied by different computing components before the statements may be generated. As a result, delays in identifying satisfied agreements may cause delays in generation of the statements. Additionally, tight dependency on the computing components for supportability exists because the agreements must be satisfied by the different computing components.

Therefore, there is a need for a statement event manager that manages statement events and corresponding agreements based on predetermined rules to facilitate automated statement generation.

### SUMMARY

The present disclosure, through one or more of its various aspects, embodiments, and/or specific features or sub-components, provides, inter alia, various systems, servers, devices, methods, media, programs, and platforms for managing statement events and corresponding agreements based on predetermined rules to facilitate automated statement generation.

According to an aspect of the present disclosure, a method for facilitating management of a plurality of statement events is disclosed. The method is implemented by at least one processor. The method may include receiving at least one event, the at least one event may relate to an agreement status of a statement; retrieving at least one profile that corresponds to the statement, the at least one profile may include at least one statement dependency and at least one rule; mapping the statement based on the at least one statement dependency and the at least one rule; aggregating data that corresponds to the statement from at least one source; determining a completion status that corresponds to the statement; and publishing at least one ready event that corresponds to the statement based on a result of the mapping, the aggregated data, and the completion status.

In accordance with an exemplary embodiment, the at least one event may relate to an indication of a change in a state corresponding to the agreement status, the at least one event may include information that relates to the state and a corresponding state identifier.

In accordance with an exemplary embodiment, the at least one statement dependency may be determined based on the at least one profile, the at least one statement dependency may include at least one potential dependent condition.

In accordance with an exemplary embodiment, the at least one source may include at least one from among a first-party data source and a third-party data source.

In accordance with an exemplary embodiment, the completion status may include at least one from among a partial completion status and a total completion status, the completion status may correspond to a predetermined guideline.

In accordance with an exemplary embodiment, the method may further include identifying historical data for the statement when the statement is associated with the partial completion status; determining whether the historical data is usable for the statement based on a corresponding service level agreement; and publishing, based on a result of the determining, the at least one ready event that corresponds to the statement according to the result of the mapping, the aggregated data, the historical data, and the completion status.

In accordance with an exemplary embodiment, prior to publishing the at least one ready event, the method may further include generating a notification, the notification may request approval to publish the at least one ready event based on the historical data; and transmitting the notification to a user.

In accordance with an exemplary embodiment, the notification may include information that relates to at least one from among the historical data, the corresponding service level agreement, and the statement.

In accordance with an exemplary embodiment, the statement may include at least one from among a bilateral statement and a combined statement.

According to an aspect of the present disclosure, a computing device configured to implement an execution of a method for facilitating management of a plurality of statement events is disclosed. The computing device including a processor; a memory; and a communication interface coupled to each of the processor and the memory, wherein the processor may be configured to receive at least one event, the at least one event may relate to an agreement status of a statement; retrieve at least one profile that corresponds to the statement, the at least one profile may include at least one statement dependency and at least one rule; map the statement based on the at least one statement dependency and the at least one rule; aggregate data that corresponds to the statement from at least one source; determine a completion status that corresponds to the statement; and publish at least one ready event that corresponds to the statement based on a result of the mapping, the aggregated data, and the completion status.

In accordance with an exemplary embodiment, the at least one event may relate to an indication of a change in a state corresponding to the agreement status, the at least one event may include information that relates to the state and a corresponding state identifier.

In accordance with an exemplary embodiment, the processor may be further configured to determine the at least one statement dependency based on the at least one profile, the at least one statement dependency may include at least one potential dependent condition.

In accordance with an exemplary embodiment, the at least one source may include at least one from among a first-party data source and a third-party data source.

In accordance with an exemplary embodiment, the completion status may include at least one from among a partial completion status and a total completion status, the completion status may correspond to a predetermined guideline.

In accordance with an exemplary embodiment, the processor may be further configured to identify historical data for the statement when the statement is associated with the partial completion status; determine whether the historical data is usable for the statement based on a corresponding service level agreement; and publish, based on a result of the determining, the at least one ready event that corresponds to the statement according to the result of the mapping, the aggregated data, the historical data, and the completion status.

In accordance with an exemplary embodiment, prior to publishing the at least one ready event, the processor may be further configured to generate a notification, the notification may request approval to publish the at least one ready event based on the historical data; and transmit the notification to a user.

In accordance with an exemplary embodiment, the notification may include information that relates to at least one from among the historical data, the corresponding service level agreement, and the statement.

In accordance with an exemplary embodiment, the statement may include at least one from among a bilateral statement and a combined statement.

According to an aspect of the present disclosure, a non-transitory computer readable storage medium storing instructions for facilitating management of a plurality of statement events is disclosed. The storage medium including executable code which, when executed by a processor, may cause the processor to receive at least one event, the at least one event may relate to an agreement status of a statement; retrieve at least one profile that corresponds to the statement, the at least one profile may include at least one statement dependency and at least one rule; map the statement based on the at least one statement dependency and the at least one rule; aggregate data that corresponds to the statement from at least one source; determine a completion status that corresponds to the statement; and publish at least one ready event that corresponds to the statement based on a result of the mapping, the aggregated data, and the completion status.

In accordance with an exemplary embodiment, the at least one event may relate to an indication of a change in a state corresponding to the agreement status, the at least one event may include information that relates to the state and a corresponding state identifier.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for managing statement events and corresponding agreements based on predetermined rules to facilitate automated statement generation.

FIG. 4 is a flowchart of an exemplary process for implementing a method for managing statement events and corresponding agreements based on predetermined rules to facilitate automated statement generation.

FIG. 5 is an architecture diagram of an exemplary process for implementing a method for managing statement events and corresponding agreements based on predetermined rules to facilitate automated statement generation.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

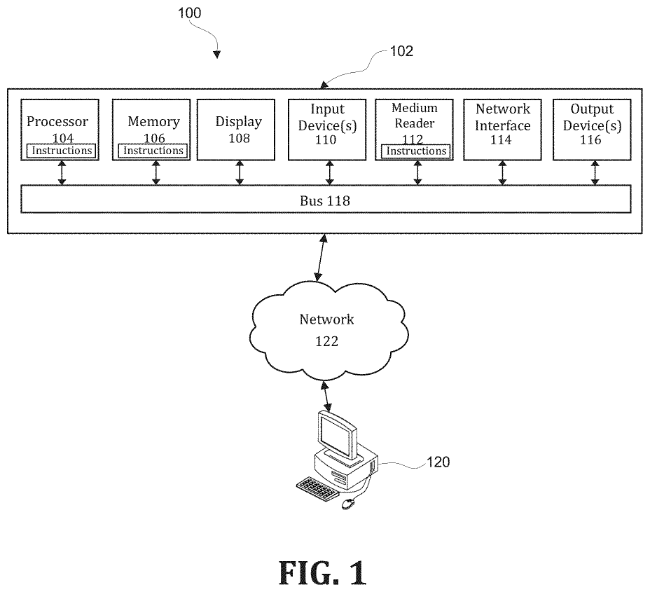

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for managing statement events and corresponding agreements based on predetermined rules to facilitate automated statement generation.

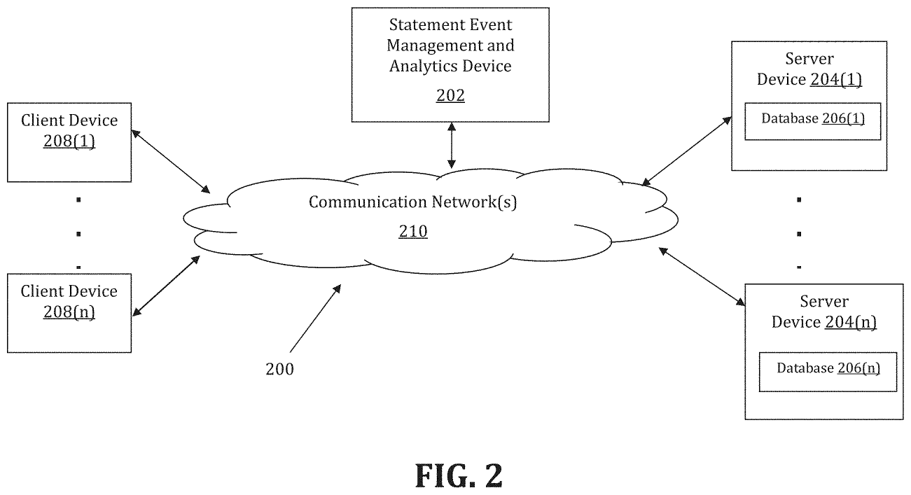

Referring to FIG. 2, a schematic of an exemplary network environment 200 for implementing a method for managing statement events and corresponding agreements based on predetermined rules to facilitate automated statement generation is illustrated. In an exemplary embodiment, the method is executable on any networked computer platform, such as, for example, a personal computer (PC).

The method for managing statement events and corresponding agreements based on predetermined rules to facilitate automated statement generation may be implemented by a Statement Event Management and Analytics (SEMA) device 202. The SEMA device 202 may be the same or similar to the computer system 102 as described with respect to FIG. 1. The SEMA device 202 may store one or more applications that can include executable instructions that, when executed by the SEMA device 202, cause the SEMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SEMA device 202 itself, may be located in virtual server(s) running in a cloud-based computing environment rather than being tied to one or more specific physical network computing devices. Also, the application(s) may be running in one or more virtual machines (VMs) executing on the SEMA device 202. Additionally, in one or more embodiments of this technology, virtual machine(s) running on the SEMA device 202 may be managed or supervised by a hypervisor.

In the network environment 200 of FIG. 2, the SEMA device 202 is coupled to a plurality of server devices 204(1)-204(n) that hosts a plurality of databases 206(1)-206(n), and also to a plurality of client devices 208(1)-208(n) via communication network(s) 210. A communication interface of the SEMA device 202, such as the network interface 114 of the computer system 102 of FIG. 1, operatively couples and communicates between the SEMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SEMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SEMA devices that efficiently implement a method for managing statement events and corresponding agreements based on predetermined rules to facilitate automated statement generation.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SEMA device 202 may be a standalone device or integrated with one or more other devices or apparatuses, such as one or more of the server devices 204(1)-204(n), for example. In one particular example, the SEMA device 202 may include or be hosted by one of the server devices 204(1)-204(n), and other arrangements are also possible. Moreover, one or more of the devices of the SEMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SEMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to events, agreement statuses, profiles, statement dependencies, rules, maps, statement data, and completion statuses.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SEMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SEMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SEMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SEMA device 202, the server devices 204(1)-204(n), or the client devices 208(1)-208(n), for example, may be configured to operate as virtual instances on the same physical machine. In other words, one or more of the SEMA device 202, the server devices 204(1)-204(n), or the client devices 208(1)-208(n) may operate on the same physical device rather than as separate devices communicating through communication network(s) 210. Additionally, there may be more or fewer SEMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

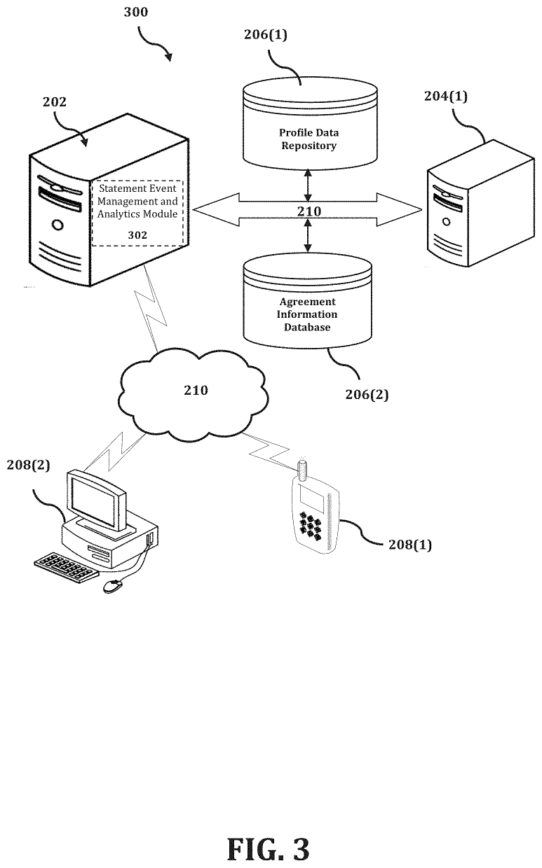

The SEMA device 202 is described and shown in FIG. 3 as including a statement event management and analytics module 302, although it may include other rules, policies, modules, databases, or applications, for example. As will be described below, the statement event management and analytics module 302 is configured to implement a method for managing statement events and corresponding agreements based on predetermined rules to facilitate automated statement generation.

An exemplary process 300 for implementing a mechanism for managing statement events and corresponding agreements based on predetermined rules to facilitate automated statement generation by utilizing the network environment of FIG. 2 is shown as being executed in FIG. 3. Specifically, a first client device 208(1) and a second client device 208(2) are illustrated as being in communication with SEMA device 202. In this regard, the first client device 208(1) and the second client device 208(2) may be “clients” of the SEMA device 202 and are described herein as such. Nevertheless, it is to be known and understood that the first client device 208(1) and/or the second client device 208(2) need not necessarily be “clients” of the SEMA device 202, or any entity described in association therewith herein. Any additional or alternative relationship may exist between either or both of the first client device 208(1) and the second client device 208(2) and the SEMA device 202, or no relationship may exist.

Further, SEMA device 202 is illustrated as being able to access a profile data repository 206(1) and an agreement information database 206(2). The statement event management and analytics module 302 may be configured to access these databases for implementing a method for managing statement events and corresponding agreements based on predetermined rules to facilitate automated statement generation.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SEMA device 202 via broadband or cellular communication. Of course, these embodiments are merely exemplary and are not limiting or exhaustive.

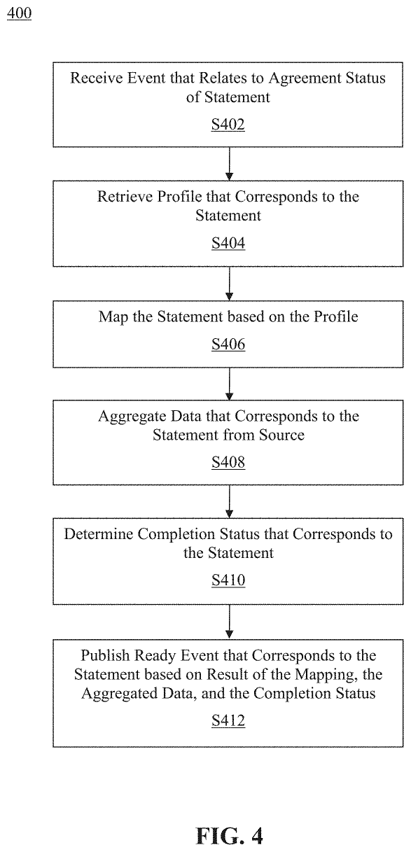

Upon being started, the statement event management and analytics module 302 executes a process for managing statement events and corresponding agreements based on predetermined rules to facilitate automated statement generation. An exemplary process for managing statement events and corresponding agreements based on predetermined rules to facilitate automated statement generation is generally indicated at flowchart 400 in FIG. 4.

In the process 400 of FIG. 4, at step S402, an event may be received. The event may relate to an agreement status of a statement. In an exemplary embodiment, the event may be received from an upstream component and correspond to an agreement ready event. The agreement ready event may relate to an indication that an agreement corresponding to the statement is satisfied. In another exemplary embodiment, the agreement may correspond to a commitment between a service provider and a client such as, for example, a service level agreement (SLA). The agreement may outline aspects of the agreed upon service such as, for example, a service quality, a service availability, and responsibilities of each party.

In another exemplary embodiment, the event may relate to an indication of a change in a state that corresponds to the agreement status. The event may include information that relates to the state and a corresponding state identifier. In another exemplary embodiment, the change in state may correspond to a change in the agreement status of the statement. For example, the state may relate to a readiness condition of the agreement that changes from not ready to ready when the agreement is satisfied.

In another exemplary embodiment, the statement may correspond to formal records of activities such as, for example, financial activities of the client. The statement may organize relevant information in a structured manner and in a form consistent with business guidelines. In another exemplary embodiment, the statement may be associated with conditions that are defined in an agreement. Satisfaction of the conditions may be required before the statement may be generated for the client. In another exemplary embodiment, the statement may include at least one from among a bilateral statement and a combined statement. The bilateral statement may correspond to a bilateral agreement between two parties in which each side agrees to fulfill their side of the bargain. The combined statement may include a summary of various client activities in a singular statement.

In another exemplary embodiment, the event and corresponding computing components may relate to a software architecture paradigm such as, for example, an event-driven architecture that promotes the production, detection, consumption of, and reaction to events. The software architecture paradigm may be applied by the design and implementation of applications and systems that transmit events among loosely coupled software components and services. An event-driven system may include event emitters, event consumers, and event channels.

In another exemplary embodiment, the applications may include at least one from among a web application, a monolithic application, and a microservice application. The monolithic application may describe a single-tiered software application where the user interface and data access code are combined into a single program from a single platform. The monolithic application may be self-contained and independent from other computing applications.

In another exemplary embodiment, the web application may correspond to application software that runs on a web server. Unlike computer-based software programs that run locally on the operating system of a device, the web application may be accessed by the user through a web browser with an active network connection. The web application may be programmed by using a client-server modeled structure wherein the user is provided services via an off-site server. The off-site server may include first-party off-site servers as well as third-party off-site servers.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, a profile that corresponds to the statement may be retrieved. The profile may include a statement dependency and a rule. In an exemplary embodiment, the profile may correspond to a collection of information that relates to the statement. For example, the profile may include information that relates to the client associated with the statement, the agreements associated with the statement, and the rules associated with the statement. In another exemplary embodiment, the statement dependency may relate to a condition that must be satisfied before the statement can be generated. Consistent with present disclosures, the statement dependency may correspond to agreements associated with the statement.

In another exemplary embodiment, the statement dependency may be determined based on the profile. The profile may include information relating to various interactions between the statement and various agreements that are usable to infer a dependency between the statement and the various agreements. For example, a dependency between statement A and agreement C may be inferred from information in the profile that indicates a dependency between statement A and agreement B, and a dependency between agreement B and agreement C. In another exemplary embodiment, the statement dependency may include a potential dependent condition. The potential dependent condition may relate to a predicted dependency that corresponds to the inferred dependency between the statement and the various agreements.

In another exemplary embodiment, the rule may relate to a predetermined guideline such as, for example, a predetermined business guideline that is associated with the statement. The rule may include a first-party guideline such as, for example, the predetermined business guideline as well as a third-party guideline such as, for example, a regulatory guideline. In another exemplary embodiment, the rule may include a threshold that is usable to determine the readiness of the statement. For example, the rules may indicate that a statement for a particular client is ready when a predetermined number of agreements is satisfied.

At step S406, the statement may be mapped based on the statement dependency and the rule. In an exemplary embodiment, the statement dependency and the rule from the profile may be associated with the statement. The association may be persisted together with statement information to facilitate future statement processing. In another exemplary embodiment, the association between the statement dependency and the rule may be stored as supplemental data such as, for example, metadata that provides information relating to the statement. Consistent with present disclosures, the supplemental data may be persisted together with statement information to facilitate future statement processing.

At step S408, data that corresponds to the statement may be aggregated from a source. In an exemplary embodiment, the data may include statement dependency data and agreement status data. For example, the data may indicate that the corresponding statement dependency has been satisfied as well as indicate that the status of a corresponding agreement has changed from not ready to ready.

In another exemplary embodiment, the source may include at least one from among a first-party data source and a third-party data source. The first-party data source may correspond to an internal data system that maintains client information. For example, to satisfy a funding requirement in a corresponding agreement, internal account data systems may provide data indicating that sufficient funds are available in a client account. The third-party data source may correspond to an external data system that maintains information corresponding to the client. For example, to satisfy a regulatory requirement in a corresponding agreement, external data systems of an exchange may provide transactional data.

At step S410, a completion status that corresponds to the statement may be determined. The completion status may be determined by using the aggregated data. In an exemplary embodiment, the completion status may include at least one from among a partial completion status and a total completion status. For example, a partial completion status may be determined for the statement based on indications from the aggregated data that some agreements have not yet been satisfied.

In another exemplary embodiment, the completion status may correspond to a predetermined guideline. Consistent with present disclosures the predetermined guideline may correspond to at least one from among a business guideline, a regulatory guideline, and an agreement guideline. For example, the predetermined guideline may indicate that satisfaction of only core agreements may be sufficient for the statement to be associated with the total completion status.

At step S412, a ready event that corresponds to the statement may be published based on a result of the mapping, the aggregated data, and the completion status. In an exemplary embodiment, the ready event may be published when the claimed system has identified that corresponding agreements are ready. Consistent with present disclosures, the claimed system may utilize the mapping, the aggregated data, and the completion status to determine that a combination of any and all corresponding agreements are satisfied. In another exemplary embodiment, the ready event may be published to initiate generation of the statement. The generated statement may be further processed by downstream event-based mechanisms for delivery to the client.

In another exemplary embodiment, historical data for the statement may be identified when the statement is associated with the partial completion status. The historical data may correspond to agreement information that relates to a previously processed statement. Then, whether the historical data is usable for the statement may be determined based on a corresponding service level agreement (SLA). For example, the SLA may indicate that historical agreement information is usable in place of missing current agreement information. The ready event that corresponds to the statement may be published based on a result of the determining. The ready event may be published according to the result of the mapping, the aggregated data, the historical data, and the completion status.

In another exemplary embodiment, a notification may be generated prior to publishing the ready event. The notification may request approval to publish the ready event based on the historical data. The notification may be transmitted to a user who is associated with the statement. In another exemplary embodiment, the notification may include information that relates to at least one from among the historical data, the corresponding service level agreement, and the statement.

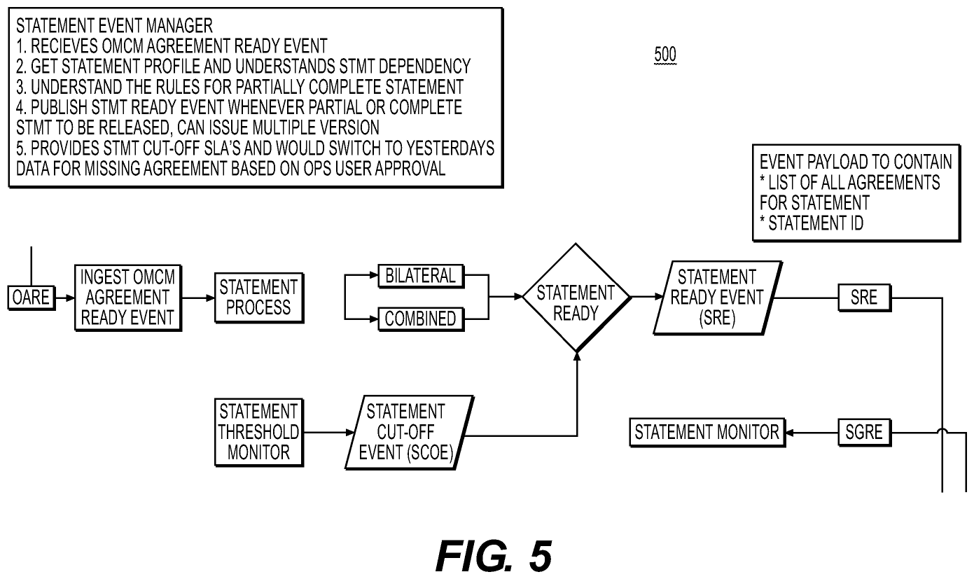

FIG. 5 is an architecture diagram 500 of an exemplary process for implementing a method for managing statement events and corresponding agreements based on predetermined rules to facilitate automated statement generation. In FIG. 5, the claimed system in integrated into a statement generation and distribution platform.

As illustrated in FIG. 5, an agreement ready event may be received. The agreement readiness event may be received based on a straight through processing (STP) flag as well as based on user inputs via a graphical user interface. Statement dependency may then be identified by using profile data. A statement readiness may be determined based on configured rules consistent with present disclosures. Finally, an event may be initiated to generate the statement and to deliver the generated statement to the client. The event may be usable to communicate with downstream components via event-based mechanisms. In another exemplary embodiment, the statement readiness determination may distinguish between bilateral and combined statements.

Accordingly, with this technology, an optimized process for managing statement events and corresponding agreements based on predetermined rules to facilitate automated statement generation is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating management of a plurality of statement events, the method being implemented by at least one processor, the method comprising:
receiving, by the at least one processor, at least one event, the at least one event relating to an agreement status of a statement;
retrieving, by the at least one processor, at least one profile that corresponds to the statement, the at least one profile including at least one statement dependency and at least one rule;
mapping, by the at least one processor, the statement based on the at least one statement dependency and the at least one rule;
aggregating, by the at least one processor, data that corresponds to the statement from at least one source;
determining, by the at least one processor, a completion status that corresponds to the statement; and
publishing, by the at least one processor, at least one ready event that corresponds to the statement based on a result of the mapping, the aggregated data, and the completion status.

2. The method of claim 1, wherein the at least one event relates to an indication of a change in a state corresponding to the agreement status, the at least one event including information that relates to the state and a corresponding state identifier.

3. The method of claim 1, wherein the at least one statement dependency is determined based on the at least one profile, the at least one statement dependency including at least one potential dependent condition.

4. The method of claim 1, wherein the at least one source includes at least one from among a first-party data source and a third-party data source.

5. The method of claim 1, wherein the completion status includes at least one from among a partial completion status and a total completion status, the completion status corresponding to a predetermined guideline.

6. The method of claim 5, further comprising:
identifying, by the at least one processor, historical data for the statement when the statement is associated with the partial completion status;
determining, by the at least one processor, whether the historical data is usable for the statement based on a corresponding service level agreement; and
publishing, by the at least one processor based on a result of the determining, the at least one ready event that corresponds to the statement according to the result of the mapping, the aggregated data, the historical data, and the completion status.

7. The method of claim 6, wherein, prior to publishing the at least one ready event, the method further comprises:
generating, by the at least one processor, a notification, the notification requesting approval to publish the at least one ready event based on the historical data; and
transmitting, by the at least one processor, the notification to a user.

8. The method of claim 7, wherein the notification includes information that relates to at least one from among the historical data, the corresponding service level agreement, and the statement.

9. The method of claim 1, wherein the statement includes at least one from among a bilateral statement and a combined statement.

10. A computing device configured to implement an execution of a method for facilitating management of a plurality of statement events, the computing device comprising:
a processor;
a memory; and
a communication interface coupled to each of the processor and the memory,
wherein the processor is configured to:
receive at least one event, the at least one event relating to an agreement status of a statement;
retrieve at least one profile that corresponds to the statement, the at least one profile including at least one statement dependency and at least one rule;
map the statement based on the at least one statement dependency and the at least one rule;
aggregate data that corresponds to the statement from at least one source;
determine a completion status that corresponds to the statement; and
publish at least one ready event that corresponds to the statement based on a result of the mapping, the aggregated data, and the completion status.

11. The computing device of claim 10, wherein the at least one event relates to an indication of a change in a state corresponding to the agreement status, the at least one event including information that relates to the state and a corresponding state identifier.

12. The computing device of claim 10, wherein the processor is further configured to determine the at least one statement dependency based on the at least one profile, the at least one statement dependency including at least one potential dependent condition.

13. The computing device of claim 10, wherein the at least one source includes at least one from among a first-party data source and a third-party data source.

14. The computing device off claim 10, wherein the completion status includes at least one from among a partial completion status and a total completion status, the completion status corresponding to a predetermined guideline.

15. The computing device of claim 14, wherein the processor is further configured to:
identify historical data for the statement when the statement is associated with the partial completion status;
determine whether the historical data is usable for the statement based on a corresponding service level agreement; and
publish, based on a result of the determining, the at least one ready event that corresponds to the statement according to the result of the mapping, the aggregated data, the historical data, and the completion status.

16. The computing device of claim 15, wherein, prior to publishing the at least one ready event, the processor is further configured to:
generate a notification, the notification requesting approval to publish the at least one ready event based on the historical data; and
transmit the notification to a user.

17. The computing device of claim 16, wherein the notification includes information that relates to at least one from among the historical data, the corresponding service level agreement, and the statement.

18. The computing device of claim 10, wherein the statement includes at least one from among a bilateral statement and a combined statement.

19. A non-transitory computer readable storage medium storing instructions for facilitating management of a plurality of statement events, the storage medium comprising executable code which, when executed by a processor, causes the processor to:
receive at least one event, the at least one event relating to an agreement status of a statement;
retrieve at least one profile that corresponds to the statement, the at least one profile including at least one statement dependency and at least one rule;
map the statement based on the at least one statement dependency and the at least one rule;
aggregate data that corresponds to the statement from at least one source;
determine a completion status that corresponds to the statement; and
publish at least one ready event that corresponds to the statement based on a result of the mapping, the aggregated data, and the completion status.

20. The storage medium of claim 19, wherein the at least one event relates to an indication of a change in a state corresponding to the agreement status, the at least one event including information that relates to the state and a corresponding state identifier.
